(19) United States
(12) Patent Application Publication
(10) Pub. No.: US 2026/0364994 A1
(43) Pub. Date: Nov. 19, 2026

(54) COMFORT-BASED CONTROL FOR TRANSIENT AND NON-UNIFORM ENVIRONMENTS

(71) Applicant: Atieva, Inc., Newark, CA (US)

(72) Inventors: Mina Michel Kamel Mikhaeel, Hayward, CA (US); Wulfer Adrijan de Bruijn, San Carlos, CA (US)

(21) Appl. No.: 19/209,450

(22) Filed: May 15, 2025

(51) Int. Cl. B60H 1/00

(52) U.S. Cl. CPC B60H 1/00742; B60H 1/0073

(57) ABSTRACT

This disclosure provides systems and methods, including computer programs encoded on storage media, method of a vehicle comfort-based control system. This control method is applicable to non-uniform and transient environments (as well as uniform and steady state ones). In some implementations, the method can include obtaining one or more input parameters. Additionally, the method can include determining, using a physiology model, one or more thermal parameters associated with one or more body areas of the occupant based on the one or more input parameters. The method can further include determining, using a psychology model, the overall thermal comfort level associated with a whole body of the occupant based on the one or more thermal parameters. The method can furthermore include adjusting, based on the overall thermal comfort level and according to a predefined efficiency/time target, climate controls of the vehicle to modify a local thermal sensation of body areas.

### TECHNICAL FIELD

The present disclosure relates generally to a climate control, and more particularly, to a method and apparatus of a vehicle comfort-based control system for controlling the climate of a vehicle.

### BACKGROUND

Thermal comfort can represent a subjective satisfaction of human experience with their surrounding thermal conditions in climate-controlled spaces. Thermal comfort manifests itself as the perception of thermal pleasantness or unpleasantness within environments regulated by heating, ventilation, and air conditioning (HVAC) systems, such as, for example, residential buildings, automotive cabins, aircraft interiors, and other enclosed spaces.

Thermal comfort in vehicular environments, for example, can directly impact overall satisfaction of a driver of a vehicle and their ability to perform their tasks (e.g., safety and productivity, etc.). On the contrary, thermal discomfort can lead to decreased alertness, increased reaction times, and reduced cognitive performance of the driver of a vehicle. Extreme temperature conditions, hot and cold, can cause physical stress, fatigue, and diminished concentration. Moreover, a driver's thermal comfort needs may differ significantly from those of passengers due to different activity levels and exposure to direct sunlight.

The thermal sensation experienced by the occupants of a vehicle is a combination of multiple environmental and physiological factors, including ambient temperature, relative humidity, air velocity, radiant heat, metabolic rate, and clothing insulation. In vehicular environments, these factors are particularly dynamic due to changing external conditions, solar radiation through windows, and varying occupant activity levels.

Traditional vehicle climate control systems typically rely on simple temperature measurements and preset comfort ranges. However, thermal comfort of occupants is highly personalized and depends on both objective environmental parameters and subjective personal preferences. The occupants may experience different thermal sensations even under identical environmental conditions due to variations in age, gender, body composition, and physiological state. Additionally, the asymmetric nature of the vehicle cabin environment, with solar radiation through windows and varying air distribution patterns, creates unique challenges in maintaining optimal thermal comfort. Furthermore, thermal comfort perception drives energy utilization patterns. When experiencing thermal discomfort, occupants typically respond by adjusting climate control systems to more energy-intensive settings. This compensatory behavior often results in substantial increases in energy consumption as individuals seek to establish conditions aligned with their comfort preferences.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In aspects of the disclosure, a method, a computer-readable medium, and an apparatus are provided. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, a method can include obtaining one or more input parameters. The method can additionally include determining, using a physiology model that predicts thermophysiological responses of the occupant, one or more thermal parameters associated with one or more body areas of the occupant based on the one or more input parameters. The method can also include determining, using a psychology model that predicts a localized and whole-body thermal sensation and comfort of the occupant, the overall thermal comfort level associated with a whole body of the occupant based on the one or more thermal parameters. In addition, the method can include adjusting, based on the overall thermal comfort level and according to a predefined efficiency target, climate controls of the vehicle to modify a local thermal sensation of the one or more body areas of the occupant to achieve the overall thermal comfort level associated with the occupant.

Other embodiments of this aspect include corresponding computer systems, apparatus, and computer programs recorded on one or more computer storage devices, each configured to perform the actions of the methods.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### DESCRIPTION OF THE DRAWINGS

The present invention is illustrated by way of example and not limitation in the figures of the accompanying drawings in which like references indicate similar elements.

FIG. 1 illustrates a schematic diagram of an exemplary scenario of a climate control system for occupants of a vehicle, in accordance with some embodiments.

FIG. 2 is a block diagram of a local (e.g., a system that accounts for the different local body parts) climate control system depicting interactions of sub-systems to control a customer experience of comfort, in accordance with some embodiments.

FIG. 3 illustrates a block diagram depicting a closed-loop feedback control mechanism utilized by the local climate system to achieve and maintain a target overall thermal comfort level, in accordance with some embodiments.

FIG. 4 is a block diagram depicting some of the input and output subsystems that interact with the climate control system, in accordance with some embodiments.

FIG. 5 is a graph of local (e.g., at a certain segment of the body) ambient conditions (temperature, relative humidity, air speed) at various points in time.

FIG. 6 are graphs of a local skin temperature and a local core temperature of various body segments over time.

FIG. 7 are graphs of a local sensation of various body segments over number of simulation runs or over time.

FIG. 8 is a graph of the overall thermal sensation at various data points or over time.

FIG. 9 is a graph of a local comfort level of various body segments over time.

FIG. 10 is a graph of the overall whole-body comfort at various data points or over time.

FIG. 11 is another graph depicting the variation of the overall comfort level and the variation of the overall power consumption with the local ambient conditions.

FIG. 12 is yet another graph depicting the variation of the overall comfort level and the variation of the time to comfort with the local ambient conditions.

FIG. 13 is a data flow diagram of some embodiments of a method of a vehicle comfort-based control system for controlling vent settings (e.g., active vents, vent angles, air temperature at the vents, air flow/speed at the vents, etc.) of a vehicle in accordance with some embodiments.

FIG. 14 is a block diagram 1400 illustrating some embodiments of a vehicle comfort-based control system in accordance with some embodiments.

FIG. 15 illustrates system level diagram of a vehicle, in accordance with some embodiments.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” or “example” or “implementation” means that a particular feature, structure, or characteristic described in connection with the embodiment can be included in at least some embodiments of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, other types).

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The terms “electric vehicle” and “EV” may be used interchangeably and refer to an all-electric vehicle.

Evaluation of thermal comfort involves one or more methodological frameworks, each with specific approaches to quantifying occupant satisfaction with their thermal environment. One approach establishes standardized ambient conditions, prescribing specific environmental parameters, typically maintaining dry bulb temperature at approximately 25° C. coupled with relative humidity at about 50%, as universal comfort thresholds. This method offers straightforward implementation but overlooks individual variations and contextual factors affecting comfort perception (e.g., transiency, non-uniformity, and the different thermal perception and level of influence of different parts of the human body).

More sophisticated approaches include Fanger's Predicted Mean Vote (PMV) and Predicted Percentage Dissatisfied (PPD) models. These internationally recognized standards quantify thermal comfort through comprehensive algorithms incorporating multiple variables: air temperature, mean radiant temperature, air velocity, relative humidity, metabolic rate, and clothing insulation. For example, the PMV approach can use a scale (−3 to +3) to predict average thermal sensation across a population, while the PPD approach estimates the percentage of occupants likely to express dissatisfaction. These models primarily address whole-body thermal sensation and these models have been widely adopted in building standards and regulations.

The Berkeley comfort model represents another approach that recognizes that thermal comfort involves both whole-body and localized perceptions of the local (or per-body-part). This model evaluates thermal sensations at specific body regions (e.g., head, torso, extremities, etc.) and integrates these assessments to predict overall comfort. By accounting for local thermal asymmetries, drafts, and temperature gradients, the Berkeley comfort model addresses limitations of whole-body approaches, particularly in environments with non-uniform and/or transient thermal conditions. Thermal sensation may refer to how cold or hot the body segments feel (e.g. between very cold and very hot, etc.). Thermal comfort may refer to how pleasant that thermal sensation is (e.g. between very uncomfortable and very comfortable, etc.). Body segments can include, for example, the head, neck, and chest of the occupant, and each segment can have one or more layers, including core, fat, muscle, and skin. It should be understood that the terms “body segment” can “body area” can be used interchangeably throughout this disclosure. The Berkeley comfort model integrates both local and whole-body thermal assessments by analyzing skin temperatures at various body segments (e.g., head skin, left foot skin temperature, etc.) and core temperature, while also considering their rates of change over time. However, the Berkeley comfort model does not contemplate the methods of determining these local skin temperatures and the core temperature.

The current automotive climate control systems often operate on simplified control algorithms that do not account for individual thermal preferences, real-time physiological responses, or the dynamic and non-uniform nature of the driving environment. The energy consumption of climate control systems also significantly impacts vehicle efficiency, particularly in electric vehicles where heating and cooling directly affect driving range. This creates a need for more sophisticated approaches to thermal comfort management that can balance individual comfort needs with energy efficiency while maintaining optimal driving conditions.

Embodiments of the present disclosure describes a comfort-based control system suitable for non-uniform and transient environments. While the commonly used control schemes target a certain temperature in the cabin, a comfort-based control system can balance the occupant overall thermal satisfaction against resource efficiency. In this way, the comfort-based control system can achieve a desired comfort level while simultaneously reducing, and potentially minimizing, both time and energy consumption. For example, the resource efficiency decreases if the amount of energy is focused on cooling a cabin of a vehicle (which can consume about 1000-2000 Watts) while the person in the cabin can produce an amount of heat on the order of 100 Watts.

Aspects of the present disclosure address the above-noted and other deficiencies by using a vehicle comfort-based control system for controlling climate controls of the vehicle to efficiently achieve a desired overall comfort in non-uniform and transient environments. The system described herein is also applicable to uniform and/or steady state environments. The system described herein is also applicable to other types of vehicles (e.g., aircrafts, spacecrafts, boats, etc.), and buildings.

The comfort-based control system uses a multi-stage approach based on a thermoregulation model (physiology model) and a transient and non-uniform thermal comfort model (psychology model). The comfort-based control system uses the output of the multi-stage approach to determine vent settings (e.g., active vents, vent angles, vent air flow, and vent air temperature, etc.) to achieve the desired comfort level according to an efficiency target (e.g., minimum energy and/or minimum time). Different body segments have different local comfort environmental preferences. For example, the pelvis prefers a warm sensation, while the breath level prefers a cooler air. In addition, specific body segments exhibit varying degrees of influence on overall thermal comfort perception, with certain areas exerting greater impact than others on whole-body comfort assessment. Moreover, local sensations and transients can be used to achieve the desired overall comfort levels, while maintaining efficient resource usage.

Embodiments of a comfort-based control system can allow the active thermal elements to operate at lower power levels while maintaining the desired comfort level of the occupant. Embodiments of a comfort-based control system can achieve faster comfort and decrease the overall time spent in a non-comfortable state while maintaining the desired comfort level of the occupant.

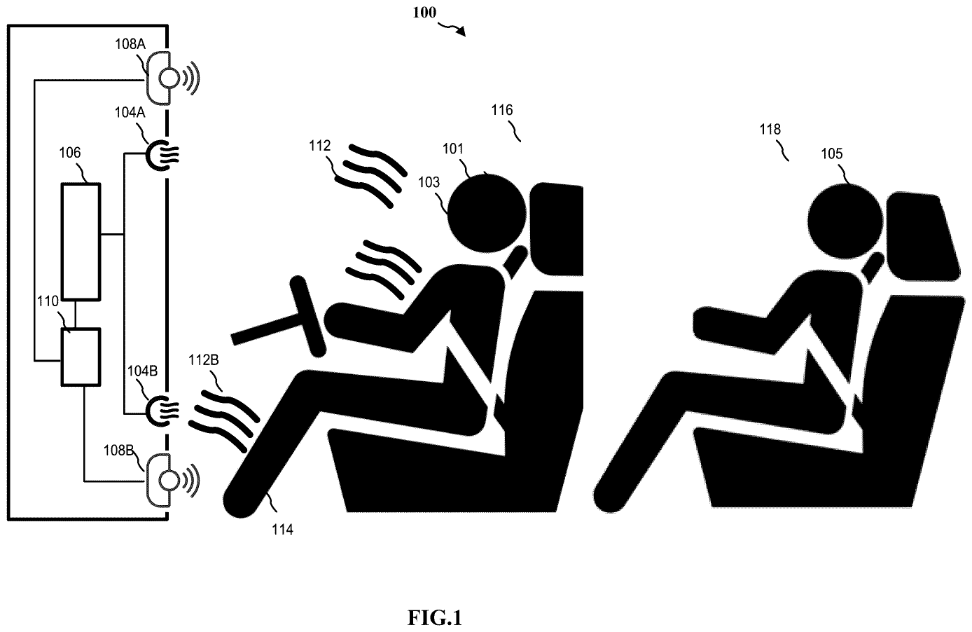

FIG. 1 is a schematic diagram of an exemplary scenario 100 of a climate control system for occupants of a vehicle, in accordance with some embodiments. Referring to FIG. 1, the vehicle is equipped with a HVAC system 106 including a plurality of vents 104A-104B. Along with a controller 110, the HVAC system 106 is configured to provide comfort for passengers by regulating the interior climate. The HVAC system 106 may be connected to a controller 110 that processes data from sensors and manages the HVAC system's operations. The controller 110 can be configured to respond to changes in temperature, humidity, and air quality, providing a consistent and comfortable climate for passengers. The controller 110 can communicate with one or more sensors 108A, 108B configured to detect cabin air temperature, solar, humidity, air speed, passenger attributes (e.g., clothing, age, weight, etc.)

The cabin of the vehicle may exhibit a highly transient and non-uniform environment. For example, asymmetric radiation and cabin de-prioritization of the cabin conditioning within an electric vehicle during a fast charge or at a low state of charge (SOC) can result in a highly transient and non-uniform environment. This means the cabin temperature changes over time (transient) and is not the same everywhere (non-uniform), potentially leading to some occupants feeling cold while others feel hot. For example, because of the non-uniform cabin temperature, the driver 101 occupying the forward cabin 116 may feel cool and the passenger 105 occupying the rear cabin 118 may feel warm. In some other examples, different body segments of the occupant can have different thermal comfort preferences. For example, the occupant may prefer that their feet have a warm sensation, while the occupants prefer their upper body (e.g., breath level area of the occupant) be exposed to cooler air.

The controller 110 can transmit a control signal to the HVAC system 106 to initiate warm air 112B to the footwell of the forward cabin 116, and the HVAC system 106 can direct the electronically controlled vent 104B to target the feet 114 of the driver 101 for a localized warming. Similarly, the HVAC system 106 can direct the electronically controlled vent 104A to target the face 103 of the driver 101 with cool air 112 for a localized cooling. This targeted approach allows for faster relief from discomfort in specific body segments of the occupant, potentially achieving the overall thermal comfort without focusing on warming or cooling the entire cabin and thus saving energy.

In some other examples, the thermal experience for different parts of the body of the occupant can be different because of the location of the vents in the cabin or the different solar/shading exposures. Similarly, the occupants of a vehicle can experience a significant transient as the vehicle is in motion, the sun's angel changes, and the outdoors temperature changes. For example, a driver and a passenger enter an electric vehicle, and the driver and the passenger can have a different thermal experience as the driver initiates the HVAC system or when sudden change in HVAC operating mode takes place due to fast charging.

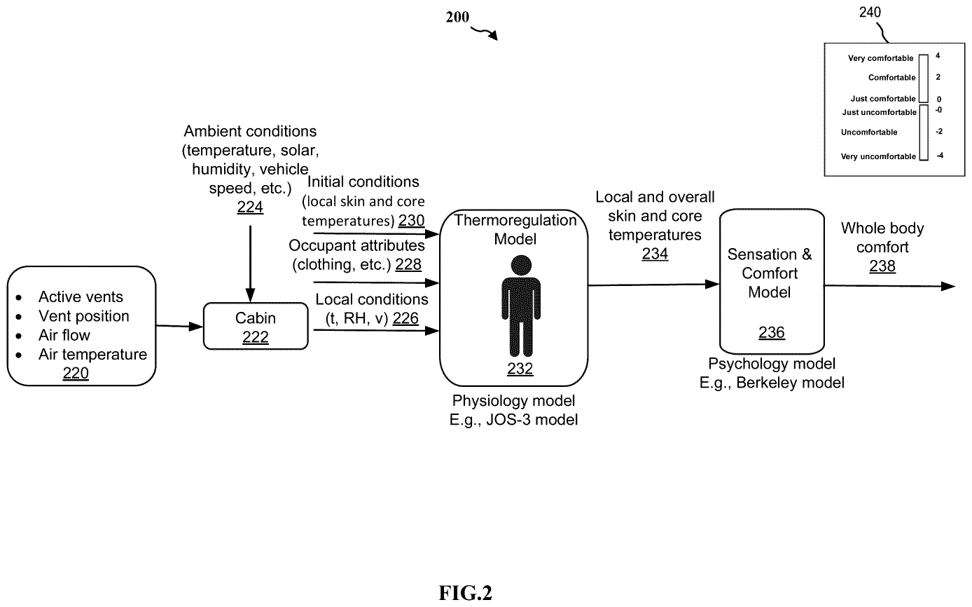

FIG. 2 is a block diagram of a local climate control system depicting interactions of sub-systems lead to the final customer experience of comfort, in accordance with some embodiments. Referring to FIG. 2, the local climate system 200 can include a physiology model 232 and a psychology model 236. In some embodiments, the local climate system 200 uses these models to determine how to adjust climate controls of a vehicle to achieve an overall thermal comfort level associated with an occupant of the vehicle. The local climate system 200 can be integrated in the controller 110 the of FIG. 1.

In some embodiments, the local climate system 200 (in FIG. 2) determines local conditions 226 at various parts of the body based on conditions in the cabin 222 of the vehicle. These conditions can include a combination of the vent-related settings 220 of the vehicle and ambient conditions 224. In some embodiments, local conditions 226 includes local air speed, air temperature, and relative humidity of the air, etc. The term “local” may refer to different parts of the body (e.g., head, right leg, etc.) of the occupant. Vent-related settings 220 of the vehicle can include an indication of which vents are active, the position of each vent (e.g., vent angles), the amount of air flow through each vent, and the temperature of the air coming out of each vent, etc. Ambient conditions 224 can include outside air temperature, solar (e.g., solar intensity and solar exposure on different parts of the vehicle potentially impacting temperature within the cabin 222), outside air humidity, the speed of the vehicle, etc.

The local conditions 226 are input to the physiology model 232 along with additional input parameters. In some embodiments, the additional input parameters include initial conditions 230 (e.g., local skin and core temperatures) and occupant attributes 228 (e.g. clothing level, occupants age, gender, etc.). In some embodiments, the local climate system 200 can obtain the attributes associated with the occupant using sensors. The sensors can include, for example, infrared sensors, piezoresistive sensors, ultrasonic sensors, etc. Note that other sensors capable of obtaining and determining the attributes associated with the occupant (e.g., infra-red (IR) sensors, IR cameras, etc.,) can be used in conjunction with the local climate system 200 and method of the techniques disclosed herein.

In some embodiments, using the physiology model 232, the local climate system 200 determines one or more thermal parameters 234 associated with one or more body areas of the occupant based on the local conditions 226 and the one or more input parameters. Note that one or more body areas may also refer to body parts of the occupant.

The one or more thermal parameters 234 can include a local skin temperature, a local core temperature of various body segments of the occupant, a rate of change of the local skin temperature of the occupant, mean skin and core temperatures, as well as time-rate of change of temperatures. Physiology model 232 can include a thermoregulation model such as joint system thermoregulation model (JOS-3). The one or more input parameters, for example, can include initial conditions 230 (e.g., initial local skin temperature, initial local core temperature of the occupant) and attributes 228 associated with the occupant. In some embodiments, attributes 228 associated with the occupant, for example, include information regarding the occupant's clothing, age, weight, etc.

In some embodiments, the output of the physiology model 232 is sent to, and input to, the psychology model 236. Using the psychology model 236, the local climate system 200 determines local body sensations, an overall sensation, local comforts, and overall or whole-body comfort, based on the one or more thermal parameters 234 as described above. In other words, based on the output of the psychology model 232, the local climate system 200 determines the overall thermal comfort level 238 associated with a whole body of the occupant.

In some embodiments, the local climate system 200 determines the overall thermal comfort level 238 based on occupant's comfort responses. For example, the local climate system 200 can request the occupant to provide responses using the thermal comfort scale 240. In some embodiments, the thermal comfort scale 240 uses a 6-point scale: 4:“very comfortable”; 2: “comfortable”; 0:“just comfortable”; −0:“just uncomfortable”, −2:“uncomfortable”, −4:“very uncomfortable”.

In some embodiments, for one or more body areas of the occupant, the local climate system 200 can determine a local thermal sensation. The local climate system 200 can identify one or more target body areas having the local thermal sensation(s) that corresponds to a maximum value of the overall thermal comfort level; and direct a vent of the vehicle to the target body area(s) to modify the local thermal sensation, and hence to modify the overall thermal comfort. The one or more target body areas having the local thermal sensation that correspond to a maximum value of the overall thermal comfort level can be associated with the one or more target body areas having the local thermal sensations that have a significant impact on the overall thermal comfort level.

In some embodiments, the local climate system 200 adjusts, based on the overall thermal comfort level and according to a predefined efficiency target, climate controls of the vehicle to modify the local thermal sensation of one or more body areas of the occupant to achieve the overall thermal comfort level associated with the occupant. In some embodiments, the predefined efficiency target includes a minimum energy budget and a minimum time to achieve the overall thermal comfort level associated with the occupant.

In some embodiments, the local climate system 200 determines the overall thermal comfort level based on: a duration of a predefined route between a start point to an end point, or an energy budget for the predefined route to achieve the overall thermal comfort level associated with the occupant.

In some aspects, the techniques described herein relate to a method of adjusting climate controls of a vehicle to achieve an overall thermal comfort level associated with an occupant of the vehicle, including: obtaining one or more input parameters; determining, using a physiology model that predicts thermophysiological responses of the occupant, one or more thermal parameters associated with one or more body areas of the occupant based on the one or more input parameters; determining, using a psychology model that predicts a localized and whole body thermal sensation and comfort of the occupant, the overall thermal comfort level associated with a whole body of the occupant based on the one or more thermal parameters; and adjusting, based on the overall thermal comfort level and according to a predefined efficiency target, climate controls of the vehicle to modify a local thermal sensation of the one or more body areas of the occupant to achieve the overall thermal comfort level associated with the occupant.

In some aspects, the techniques described herein relate to a vehicle, including: a control system including: a processor, a memory coupled to the processor to store instructions, which when executed by the processor, cause the processor to perform operations, the operations including: obtaining one or more input parameters; determining, using a physiology model that predicts thermophysiological responses of an occupant, one or more thermal parameters associated with one or more body areas of the occupant based on the one or more input parameters; determining, using a psychology model that predicts a localized and whole body thermal sensation and comfort of the occupant, an overall thermal comfort level associated with a whole body of the occupant based on the one or more thermal parameters; and adjusting, based on the overall thermal comfort level and according to a predefined efficiency target, climate controls of the vehicle to modify a local thermal sensation of the one or more body areas of the occupant to achieve the overall thermal comfort level associated with the occupant.

In some aspects, the techniques described herein relate to a non-transitory machine-readable storage medium having instructions stored therein, which when executed by a processor, cause the processor to perform operations, the operations including: obtaining one or more input parameters; determining, using a physiology model that predicts thermophysiological responses of an occupant, one or more thermal parameters associated with one or more body areas of the occupant based on the one or more input parameters; determining, using a psychology model that predicts a localized and whole body thermal sensation and comfort of the occupant, an overall thermal comfort level associated with a whole body of the occupant based on the one or more thermal parameters; and adjusting, based on the overall thermal comfort level and according to a predefined efficiency target, climate controls of a vehicle to modify a local thermal sensation of the one or more body areas of the occupant to achieve the overall thermal comfort level associated with the occupant. For example, to drive home from work is expected to take about 15 minutes. The local climate system 200 recognizes the duration, based on historical data or the navigation system data, and the local climate system 200 can configure the vent settings to achieve the overall thermal comfort level for the trip, which is approximately 15 minutes long. This way, the driver can enjoy the overall thermal comfort before the driver reaches their destination. In other words, the comfort control system described herein can devise a control strategy or path to overall thermal comfort that takes into account the duration of the trip (e.g., a short commute to work versus a few hours trip).

In some embodiments, the local climate system 200 provides intuitive feedback to the occupant regarding the system's determination to modify a local thermal sensation of the one or more body areas of the occupant. In some embodiments, the local climate system 200 projects subtle visual overlays onto the windshield providing a direct visualization of the system's thermal management strategy. For example, a faint blue aura around the dashboard vents can indicate localized cooling being directed towards the feet of the occupant. In some other embodiments, a faint orange aura emanating from the seat area can suggest the system is initiating subtle heating due to a perceived cooling trend.

In some other examples, the local climate system 200 displays an icon that visually represents the overall thermal comfort level associated with the occupant. For example, when the local climate system 200 modifies the local thermal sensation of the one or more body areas, the icon can briefly animate (e.g., a subtle pulse) to indicate an action has been taken based on the assessed thermal state. This approach provides feedback without requiring the occupant to read any text or display indicia in the vehicle, making it less distractive, intrusive, and more intuitive, especially while driving.

The following embodiments illustrate various embodiments of the local climate system 200 adjusting climate controls of the vehicle. These various embodiments are not intended to limit the scope of the present disclosure. As will be described in detail below, various automotive components and systems can be adjusted to modify a local thermal sensation of the one or more body areas of the occupant to achieve the overall thermal comfort level associated with the occupant.

In some embodiments, the local climate system 200 instructs a controller to modify individual vent settings of the vehicle to achieve energy efficiency and/or faster comfort achievement while maintaining the desired comfort level of the occupant.

In some other embodiments, in combination with modifying the vent settings of the vehicle, the local climate system 200 also uses a localized climate zoning with individual dynamic energy budgeting and allocation strategies based on predicted or real-time needs. The local climate system 200 can divide the cabin interior of the vehicle into predefined thermal zones with individual microclimate devices and air vents. The local climate system 200 can allocate an “energy budget” to each zone based on an occupancy and learned preferences. For example, the driver's zone might get a slightly higher energy allocation initially. By focusing on the occupied zones and managing the energy distribution, the local climate system 200 can achieve comfort for each occupant faster and with less overall energy expenditure compared to uniformly conditioning the entire cabin.

In some other embodiments, in combination with modifying the vent settings of the vehicle, the local climate system 200 implements a dynamic and adaptive airflow vectoring based on thermal gradients and localized thermal feedback. The local climate system 200 can use advanced airflow direction control (e.g., electronically controlled vents) to direct air to warmer or cooler areas of the occupant's body as detected by the IR sensor. If the occupant reports feeling cold feet, the system can prioritize airflow to the footwell. This targeted approach allows for faster relief from discomfort in specific areas, potentially achieving overall comfort with less extreme cabin temperature changes and thus saving energy.

In some other embodiments, in combination with modifying the vent settings of the vehicle, the local climate system 200 dynamically adjusts the thermal system by generating a degree of thermal asymmetry around the occupant based on their initial state and a desired comfort direction. For example, if the occupant feels hot, the local climate system 200 can initially focus on cooling the upper body and face (areas with higher sensitivity to temperature changes) more aggressively while providing less intense cooling to the lower body. This targeted asymmetry can lead to a faster perception of comfort improvement, allowing the system to reach a stable, energy-efficient state sooner.

In some other embodiments, in combination with modifying the vent settings of the vehicle, the local climate system 200 implements a predictive thermal comfort approach by integrating data from various sources to predict the occupant's thermal needs and proactively adjust the environment. For example, the local climate system 200 can analyze one or more of driving style (e.g., aggressive acceleration/braking might indicate an increased metabolic heat, etc.), time of day (e.g., circadian rhythms influence thermal perception, etc.), calendar information (e.g., suggesting activities like gym visits that can affect pre-entry thermal state, etc.), and wearable device data (e.g., to monitor heart rate or skin temperature trends before entry, etc.). Based on this analysis, the local climate system 200 can anticipate the thermal discomfort that is going to occur and make climate adjustments. By anticipating the thermal discomfort, the local climate system 200 can make smaller, more energy-efficient adjustments before the occupant notices a problem, thus reducing the need for large, energy-intensive corrections later and decreasing the overall time spent in a non-comfortable state.

In some other embodiments, in combination with modifying the vent settings of the vehicle, the local climate system 200 passively improves thermal comfort through material properties of the vehicle. For example, in some embodiments, the materials (e.g., seat fabric, dashboard surfaces, etc.) of the interior of the vehicle are designed with specific thermal properties (e.g., high thermal conductivity or phase-change materials), and the climate system 200 can leverage these properties to more efficiently transfer heat to or from the occupant. For example, a seat with high thermal conductivity can enhance the effect of seat heating/cooling, leading to faster comfort and potentially allowing the active thermal elements to operate at lower power levels for shorter durations.

Note that other techniques of obtaining energy efficiency and faster comfort achievement while maintaining the desired comfort level of the occupant can be used in conjunction with the system and method of the present disclosure.

In some embodiments, the local climate system 200 can detect a change in one or more of the local conditions. The local climate system 200 can update the overall thermal comfort level, in response to the change in the one or more local conditions, to create an updated overall thermal comfort level. That is, the local climate system 200 can adjust the local conditions based on the updated overall thermal comfort level. For example, the occupant of the vehicle provides user inputs to (e.g., adjusts the angle of the vents) to the climate control of the vehicle. Based on the user inputs (e.g., adjustment of the angle of the vents), the local climate system 200 overwrites and/or sets the user inputs by adjusting the local conditions based on the updated overall thermal comfort level.

In some embodiments, the local climate system 200 generates feedback notifying the occupant of the change in the one or more of the local conditions in response to the detecting the change in the one or more local conditions. For example, in some embodiments, the local climate system 200 alerts the occupant regarding the change in the one or more of the local conditions via a haptic feedback, an auditory feedback, a visual display, etc. When the occupant manually adjusts the vent setting as described above, the feedback provides a response on how the action of the occupant is perceived by the system. This can allow the occupant to understand how their actions align with the system's thermal comfort control. Note that other feedback mechanism capable of alerting the occupant regarding the change in the or more of the local conditions can be used in conjunction with the system and method of the present disclosure.

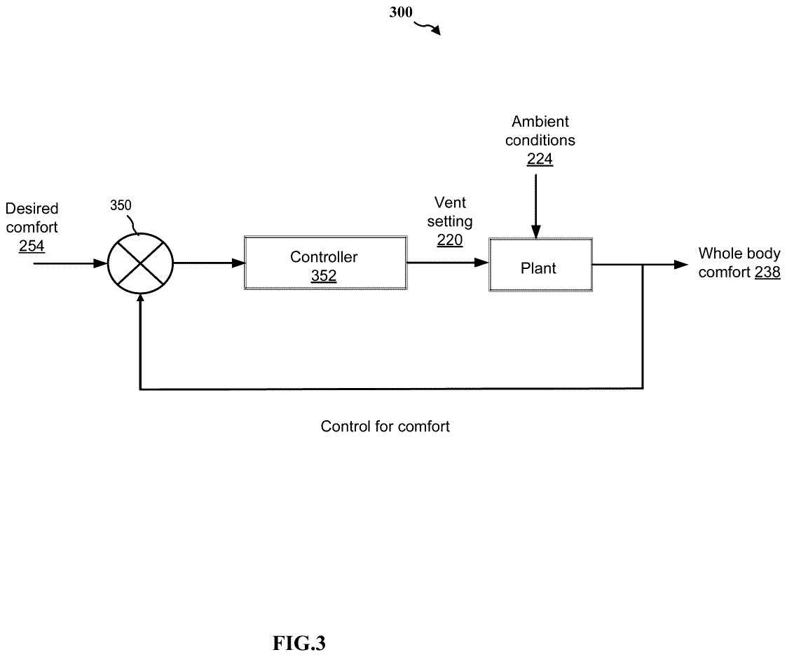

FIG. 3 is a block diagram depicting a closed-loop feedback control mechanism utilized by the local climate system to achieve and maintain a target overall thermal comfort level, in accordance with some embodiments. Referring to FIG. 3, the system implements a closed-loop feedback control mechanism 300 to achieve and maintain a target overall thermal comfort level 254. In some embodiments, the closed-loop feedback control mechanism 300 also includes a comparator 350 that calculates the deviation between the measured thermal comfort level and the target overall thermal comfort level 254.

In some embodiments, the closed-loop feedback control mechanism 300 also includes a controller 352 that generates corrective signals based on calculated deviation to achieve and maintain a target overall thermal comfort level 254. The controller 352 can use an algorithm (e.g., hybrid proportional-integral-derivative (PID)) to dynamically adjust the climate controls of the vehicle. For example, based on the corrective signals, the controller 352 transmits control signals to the HVAC system of the vehicle to adjust vent settings 220 of the vehicle. The controller 352 balances the overall comfort experience against the energy efficiency by utilizing a composite objective function which reduces, and potentially minimizes, the time to achieve a target overall thermal comfort level, the energy to achieve an overall thermal comfort level, and/or the energy consumption for a specific trip. The method described herein can also be applied using other control techniques (i.e. not limited to PID control).

In some embodiments, during an optimization process, the controller 352 determines the desired overall thermal comfort level 254 for various combinations of input parameters. For example, the controller 352 determines the desired overall thermal comfort level 254 for a combination of initial conditions 230, certain ambient conditions 224, and attributes 228 associated with the occupant. In some embodiments, results of the optimization process (e.g., different thermal comfort values at different vent settings and different ambient conditions) are stored in memory (e.g., lookup tables and/or correlations) to program one or more microcontrollers that control the vent settings. The stored data can be used to determine the vent settings to achieve the overall thermal comfort with reduced, and potentially minimum, energy and time.

In some embodiments, the controller 352 can display the overall thermal comfort scale to the occupant. This score can be the system's interpretation of the occupant's current overall thermal comfort scale based on the analysis of the combinations of input parameters.

In some other embodiments, the local climate system uses mathematical models or equations that represent the relationships between the overall thermal comfort level 254 and various combinations of input parameters (e.g., vent settings 220, certain ambient conditions 224, initial conditions 230, and attributes 228 associated with the occupant). These models or equations can be personalized for each occupant based on their profile and learned preferences and can be used in the same ways as the stored values for the optimization process.

In some other embodiments, the local climate system uses machine learning algorithms trained on historical data of occupant preferences and environmental conditions. These algorithms, such as regression models or neural networks, can learn the complex relationships between the overall thermal comfort level 254 and various combinations of input parameters (e.g., certain ambient conditions 224, vent settings 220, initial conditions 230, and attributes 228 associated with the occupant). For example, the trained model obtains input data such as current sensor data, system's control strategy (saving time and energy based on the planned trip of the vehicle determined by the navigation system), and user preference (e.g., desired thermal settings, time, and energy savings mode) and predicts the desired overall thermal comfort level. The machine learning algorithms can identify more subtle influencing factors leading to more nuanced and personalized comfort control.

In some other embodiments, the local climate system uses a combination of the above-described methods. For instance, the local climate system uses look-up tables to store baseline or default settings based on a generic profile of the occupant. Then, the local climate system can use the machine learning model or the mathematical models or equations to fine-tune these settings in real-time based on the specific occupant's thermal state and learned preferences. In some other examples, the local climate system can use the data from the lookup tables to generate initial data for the machine learning model.

In some embodiments, the training of the machine learning model integrates contextual information beyond basic temperature and humidity readings. For example, GPS data can provide weather information (e.g., weather patterns for the current location, etc.) or anticipate climate changes based on the route. Calendar information can predict the thermal state of the occupant (e.g., anticipating a need for cooling after a scheduled workout, etc.). Vehicle usage patterns (e.g., typical trip duration, time of day of use, etc.) can be used to anticipate thermal needs and pre-condition the cabin of the vehicle more effectively, saving time, and energy.

In some embodiments, the local climate system dynamically adapts the overall comfort level and the system's control strategy based on the occupant's long-term thermal history, preferences across different scenarios (e.g., driving vs. parked, different times of day, etc.), and predicted states (e.g., anticipating discomfort based on prolonged exposure to certain conditions).

In some embodiments, instead of solely relying on the training of the machine learning model within a single vehicle, the system uses cloud connectivity to create a more robust and faster learning experience. Anonymized data about user preferences in various conditions (e.g., outside temperature, inside temperature, humidity, time of day, etc.) can be aggregated from a fleet of vehicles. This aggregated data can then be used to create more informed initial microclimate profiles for new users or when a user enters a new vehicle.

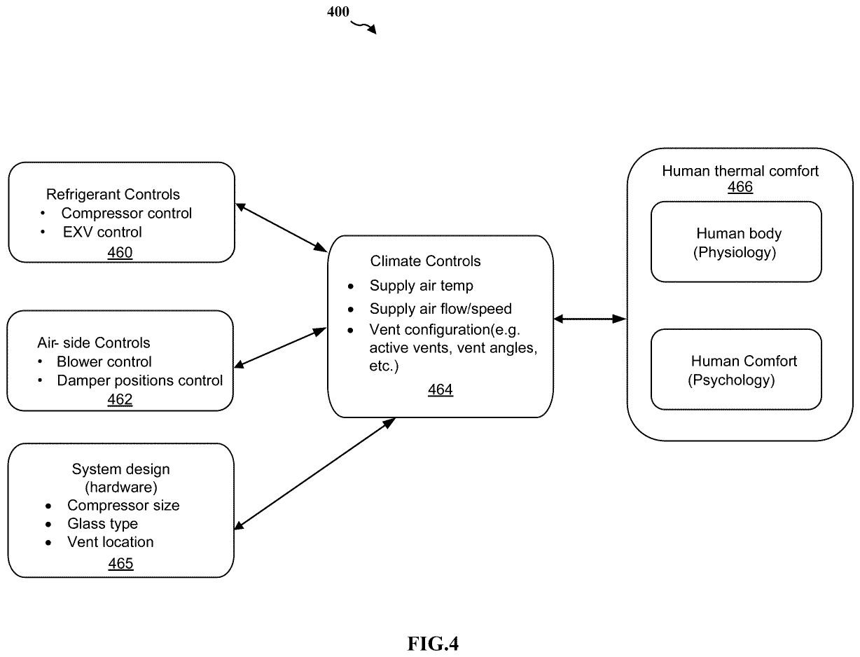

FIG. 4 is a block diagram depicting some of the input and output subsystems that interact with the climate control system. The inputs of the climate control system 400 can include the refrigerant control system 460 (which among others controls the supply air temperature from the vents), the air control system 462 (which among others controls the supply air flow/speed from the vents), and the system design (e.g., hardware) 465 which imposes constraints that the control systems can only overcome to some extent (e.g. the glass type, the compressor size, internal design of the cabin and how it impacts air flow, the vent locations, etc.). At the outputs of the climate control system are the actual occupants of the vehicle that experience a certain level of overall comfort 466 (which comprise two main parts physiology and psychology). Referring to FIG. 4, the inputs of the climate control system 400 can include refrigerant controls 460, air-side controls 462, and system hardware design 465. The outputs of the climate control system include the occupants 466 (e.g., physiology and psychology). In some embodiments, the climate control system includes a refrigerant system control (e.g., compressor control, expansion device control), and an air-system control (e.g., blower control and damper control).

In some embodiments, the refrigerant controls 460 can include a compressor control and electronic expansion valve (EXV) control. The compressor control modulates refrigerant mass flow and pressure differential through variable-speed operation, improving system efficiency across diverse thermal loads. In some embodiments, the controller continuously adjusts compressor frequency based on real-time monitoring of suction pressure, discharge temperature, and cooling demand signals. The EXV control regulates refrigerant flow in the EV thermal management systems through precision stepper motor actuation. In some embodiments, the system continuously monitors temperatures of the cabin and battery, refrigerant superheat, and system pressures to dynamically adjust valve position.

In some embodiments, the air-side controls 462 manage the movement and conditioning of air through the HVAC system via regulation of blower speed, damper positioning, and air distribution pathways. The air-side controls can improve, and potentially optimize, both thermal comfort and energy efficiency by delivering the required air volume at the minimum power consumption necessary to satisfy conditioning demands.

In some embodiments, the climate controls 464 orchestrates thermal comfort through regulation of supply air temperature, volumetric flow rate, and vent configuration. The supply air temperature controller can use a cascade control mechanism where the primary loop maintains zone temperature setpoints while the secondary loop governs heating/cooling element operation to achieve the calculated supply air temperature target. This dual-loop structure enables predictive temperature adjustment based on thermal load forecasting. Concurrently, in some embodiments, the airflow management subsystem modulates blower speed to deliver improved, and potentially optimal, air volume, balancing between rapid temperature response and energy efficiency while maintaining noise levels within acceptable parameters. The vent configuration can utilize electronically actuated dampers and directional vents with position feedback to direct conditioned air to occupied zones. The integrated controller continuously optimizes parameters (e.g., temperature, flow rate, and distribution pattern, etc.) through a multi-objective algorithm that minimizes time and energy consumption while maximizing occupant comfort level.

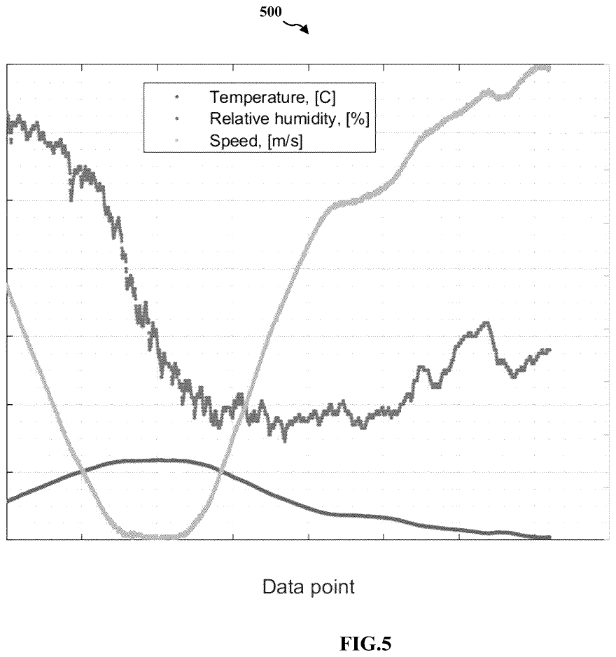

FIG. 5-FIG. 12 illustrate graphs showing the results of performing climate control using the techniques disclosed herein. The terms used in the legends of the x-axis of all the graphs: “data point”, “run #”, “simulation point”, and “Time [sec]” can be used interchangeably. The terms used in the legends of the y-axis of all the graphs: “temperature,” “sensation index [−4 (very cold) to 4 (very hot),” “overall (e.g., whole-body) sensation,” “local comfort,” “overall whole-body comfort, “power consumption,” can also be used interchangeably.

FIG. 5 is a graph of local (e.g., at a certain segment of the body) ambient conditions 500 (temperature, relative humidity, air speed) at various points in time. Referring to FIG. 5, the x-axis represents the data points/time, and the y-axis represents the value of the local conditions. The line graphs show varying values of the temperature, relative humidity, air speed at different data points.

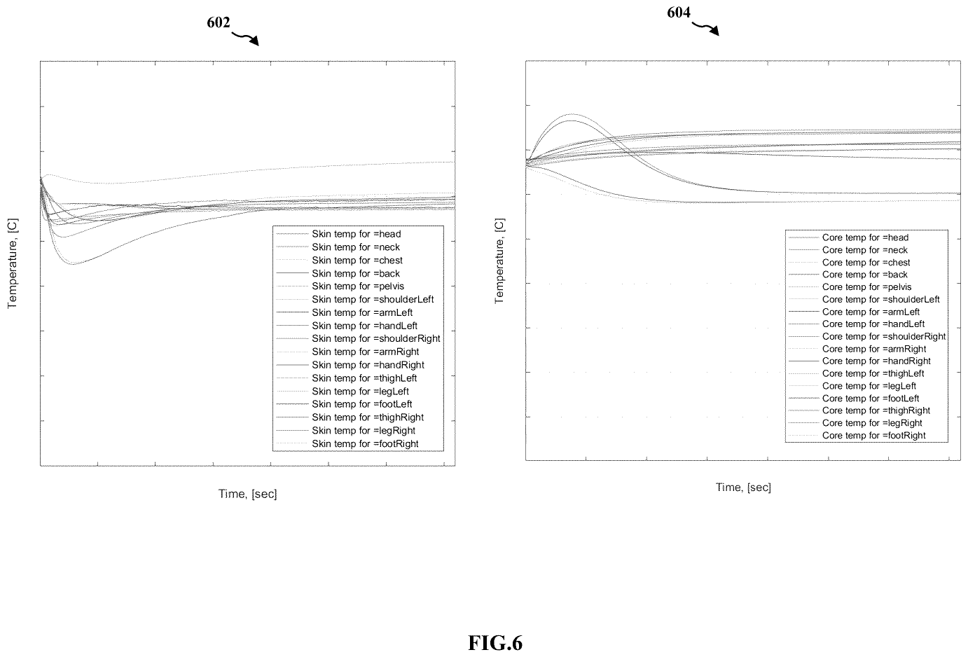

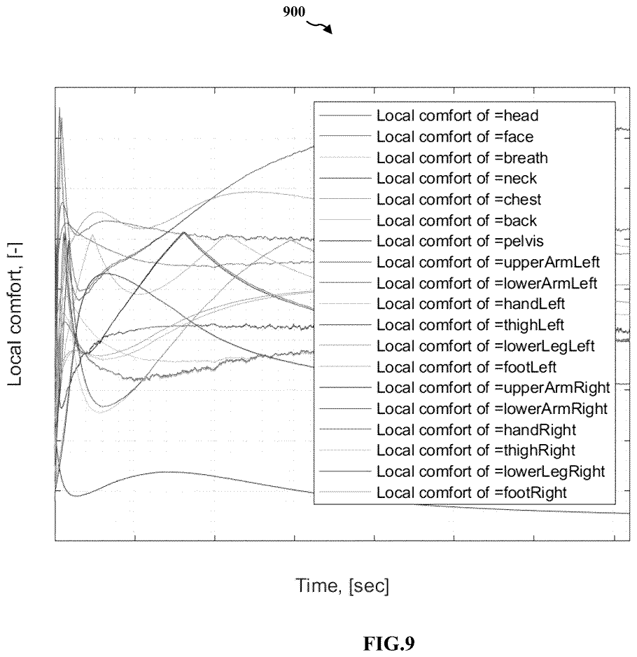

FIG. 6 are graphs of a local skin temperature and a local core temperature of various body segments over time. Referring to FIG. 6, the x-axis represents the time, and the y-axis represents the value of the local skin temperature and local core temperature. The line graphs 602 show varying values of the local skin temperature of various body segments over time. The line graphs 604 show varying values of the local core temperature of various body segments over time. Note that while the line graph 602, the line graph 604, and FIG. 9 show a particular segmentation of the human body into particular body parts (e.g., head, neck, chest, etc.), other segmentations of the human body into different body parts may be used in conjunction with the embodiments of the present disclosure.

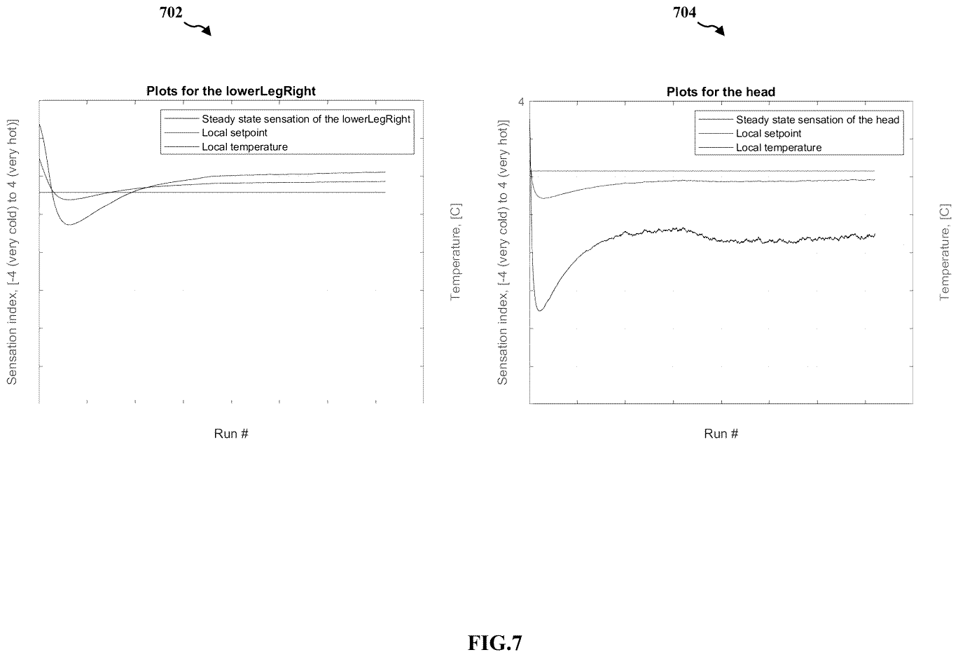

FIG. 7 are graphs of a local sensation of various body segments over number of simulation run/time. Referring to FIG. 7, the x-axis represents the number of simulation run/time, and the y-axis represents the value of the local sensation index. The line graphs 702 show varying values of the local sensation index for the lower left right over a number of run. The line graphs 704 show varying values of the local sensation index for the head over a number of run. The line graph 702 and line graph 704 also show the local skin temperature and the local set point, where temperatures can be shown on the right y-axis and the local sensation index is shown on the left y-axis.

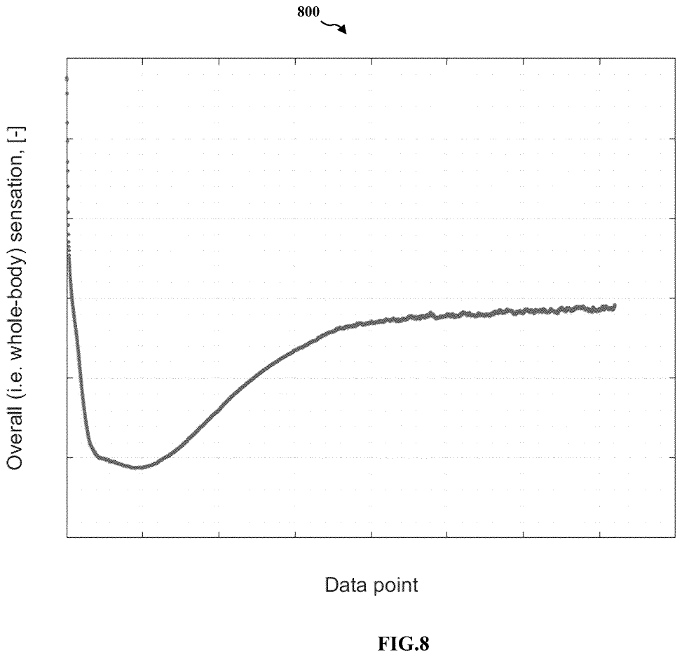

FIG. 8 is a graph 800 of the overall thermal sensation at various data points/time. Referring to FIG. 8, the x-axis represents the data points/time and the y-axis represents the value of the overall thermal sensation. The line graph shows varying values of the overall/whole-body thermal sensation at different data points/time.

FIG. 9 is a graph 900 of a local comfort level of various body segments over time. Referring to FIG. 9, the x-axis represents the time, and the y-axis represents the value of the local comfort level, and the line graph 900 shows varying values of the local comfort level of various body segments over time. As described above, note that while the line graph 900 shows a particular segmentation of the human body into particular body parts (e.g., head, neck, chest, etc.), other segmentations of the human body into different body parts may be used in conjunction with the embodiments of the present disclosure.

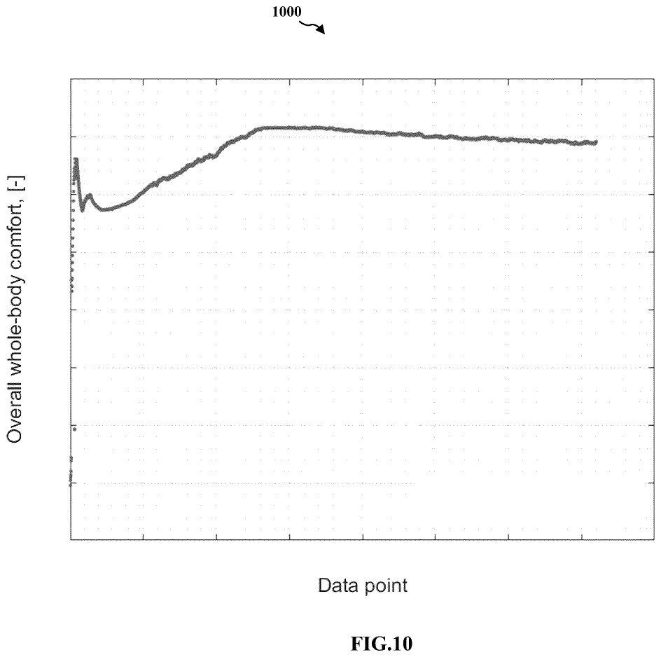

FIG. 10 is a graph of the overall whole-body comfort at various data points/time instances. Referring to FIG. 10, the x-axis represents the number of data points/time, and the y-axis represents the value of the overall/whole-body comfort, and the line graphs shows varying values of the overall whole-body comfort for different points or over time. FIGS. 6, 7, 8, and 9 represent the internal inputs/outputs of the combined physiology-psychology model; FIG. 5 represents the input to the combined model (local ambient conditions); and FIG. 10 is the output of the combined model (whole-body thermal comfort).

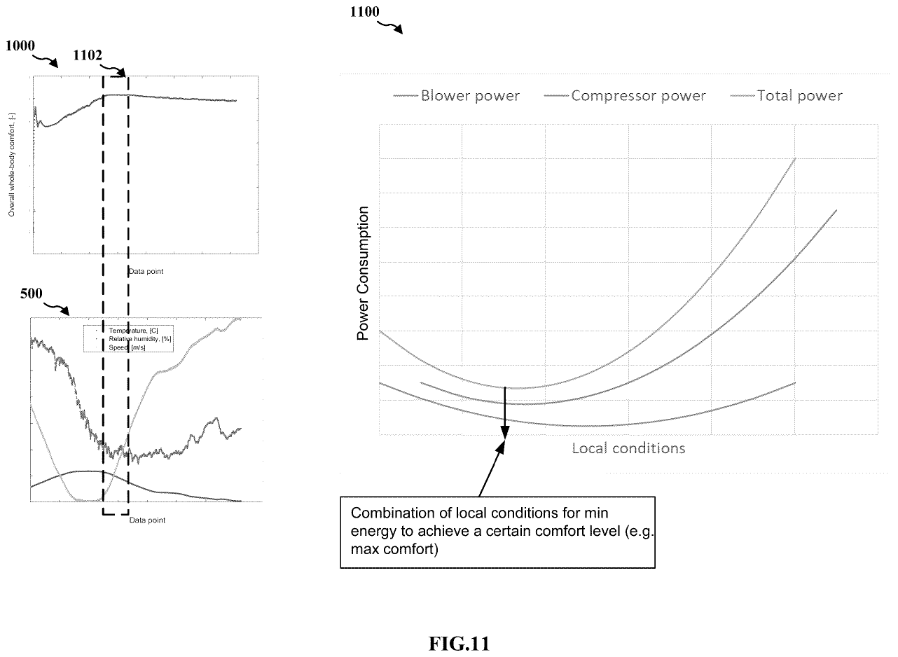

FIG. 11 shows a graph 1000 of the overall whole-body comfort at various data points (e.g., different combinations of local conditions 500). Referring to FIG. 11, the x-axis of a graph 1100 represents the local conditions, and the y-axis of the graph 1100 represents the value of the power consumption. The overlapping region 1102 indicates the combinations of local conditions that offer the max comfort. The line graphs 1100 show the combination of local conditions that correspond to the minimum energy consumption (e.g., sum of compressor power and blower power) to achieve the maximum thermal comfort under certain ambient conditions and certain parameters.

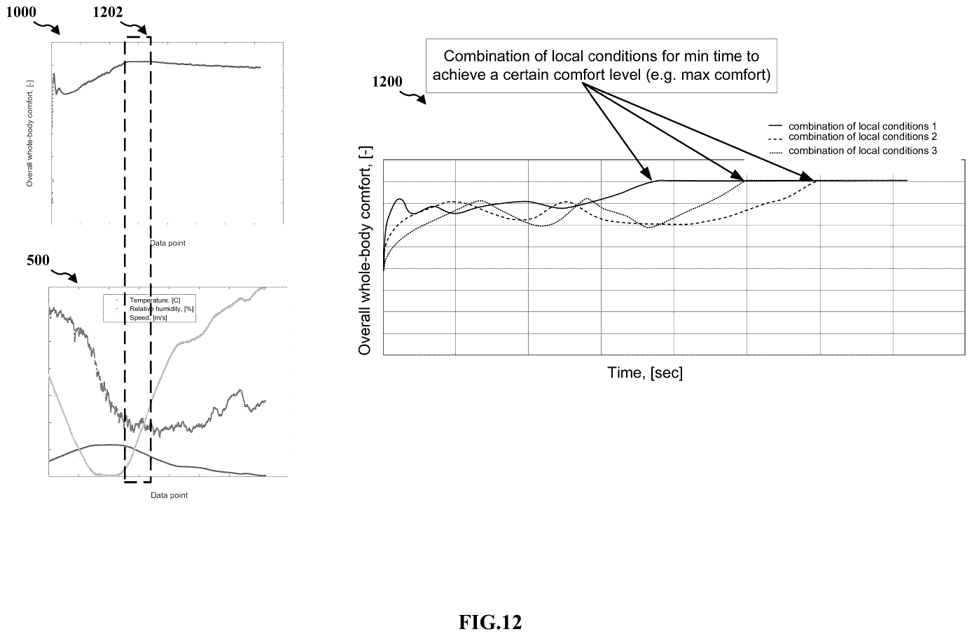

FIG. 12 shows a graph 1000 of the overall whole-body comfort at various data points (e.g., different combinations of local ambient conditions 500). Referring to FIG. 12, the x-axis of graph 1200 represents the time, and the y-axis of graph 1200 represents the value of the overall thermal comfort. The overlapping region 1202 indicates the combination(s) of local conditions that offer the max comfort, or a certain comfort level, under certain ambient conditions and certain parameters (e.g., level of clothing etc.). The line graphs 1200 show the combination of local conditions (e.g., air temperature, air humidity, and air speed for the different body parts, etc.) that correspond to the minimum time to achieve the maximum thermal comfort under certain ambient conditions and certain parameters.

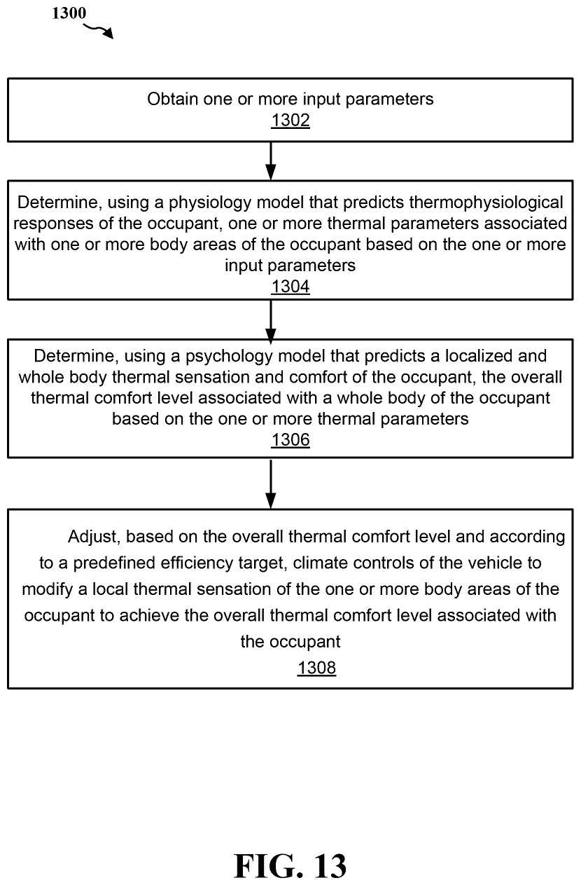

FIG. 13 is a data flow diagram of some embodiments of a method of a vehicle comfort-based control system for controlling vent settings of a vehicle in accordance with some embodiments. The method may be performed by processing logic that may comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method may be performed based on aspects of FIGS. 1-12.

With reference to FIG. 13, the method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

The method begins at block 1302, where processing logic obtains one or more input parameters. For example, referring to FIG. 2, the local climate system 200 can obtain the one or more input parameters (e.g., attributes associated with the occupant, ambient conditions, etc.) using one or more sensors, as described above.

As also shown in FIG. 13, at block 1304, processing logic determines, using a physiology model that predicts thermophysiological responses of the occupant, one or more thermal parameters associated with one or more body areas of the occupant based on the one or more input parameters. For example, referring to FIG. 2, using a physiology model 232, the local climate system 200 can determine one or more thermal parameters 234 associated with one or more body areas of the occupant based on the local conditions 226 and one or more input parameters, as described above.

As further shown in FIG. 13, at block 1306, processing logic determines, using a psychology model that predicts a localized and whole-body thermal sensation and comfort of the occupant, the overall thermal comfort level associated with a whole body of the occupant based on the one or more thermal parameters. For example, referring to FIG. 2, using a psychology model 236, the local climate system 200 can determine the local body sensation, the overall sensation, local comfort, and overall thermal comfort, based on the one or more thermal parameters 234, as described above.

As additionally shown in FIG. 13, at block 1308, processing logic adjusts, based on the overall thermal comfort level and according to a predefined efficiency target, the climate controls of the vehicle to modify a local thermal sensation of the one or more body areas of the occupant to achieve the overall thermal comfort level associated with the occupant. For example, referring to FIG. 2, the local climate system 200 can interact with a controller that adjusts the vent settings of the vehicle, as described above. Other automotive settings can be adjusted based on the overall thermal comfort level and according to a predefined efficiency/time-to-comfort target.

Although FIG. 13 shows example blocks of data flow diagram 1300, in some implementations, data flow diagram 1300 may include additional blocks, fewer blocks, different blocks, or differently arranged blocks than those depicted in FIG. 13. Additionally, or alternatively, two or more of the blocks of data flow diagram 1300 may be performed in parallel.

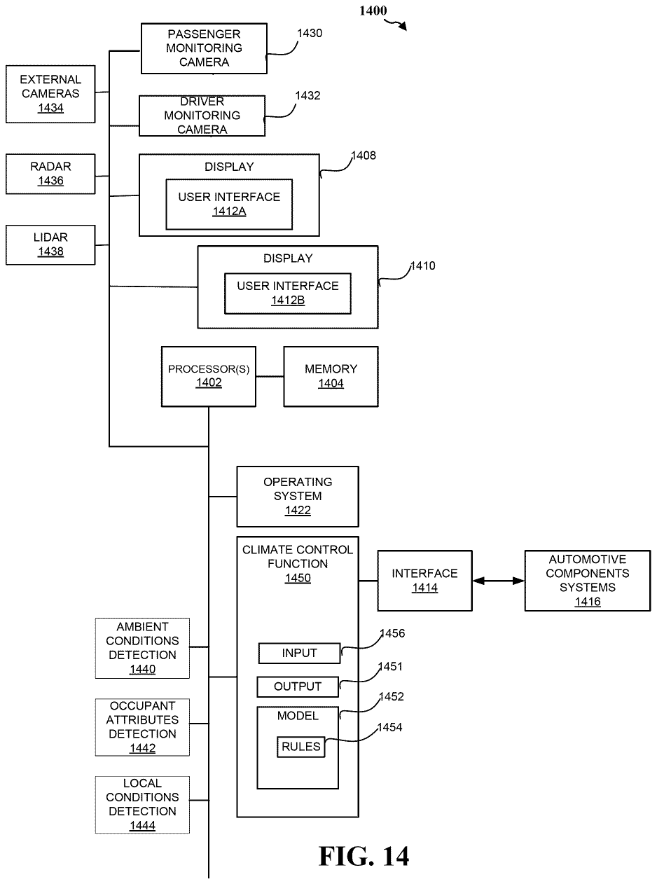

FIG. 14 is a block diagram 1400 illustrating some embodiments of a vehicle comfort-based control system in accordance with some embodiments. One or more processors 1402 coupled to memory 1404 perform processing duties according to various software, hardware, firmware, or combination modules. The processor(s) 1402 and memory 1404 are coupled to a passenger monitoring camera 1430, a driver monitoring camera 1432, external cameras 1434, radar 1436, LIDAR 1438, a first display 1408 (e.g. having a display screen) on which a user interface 1412A is displayed, a second display 1410 on which a user interface 1412B is displayed.

Also, the processor(s) 1402 and memory 1404 are coupled to an operating system 1422, an ambient conditions detection 1440, an occupant attributes detection 1442, local conditions detection 1444, and a climate control function 1450. The climate control function 1450 has an input module 1456, and output module 1451, and in some embodiments includes a model 1452 with rules 1454. Other forms of models may be used in some embodiments. The climate control function 1450 can be coupled to an interface 1414 which can be coupled to automotive components and systems 1416 in order to control, adjust or otherwise provide input to such components and systems. Automotive components and systems 1416 can include vent operations (e.g., active vents, vents angles, air circulation operations, general HVAC operations, etc.), One form of implementation is special programming of the system, more specifically special programming of the processor(s) 1402. It should be appreciated that structure of the various modules is determined by their functionality, in some embodiments.

In an operating scenario, which describes functionality of some embodiments, one or more input parameters are obtained by the ambient condition detection 1440, occupant attributes detection 1442, and local conditions detection 1444. Also, a calibration model can be built to determine the local conditions, as a function in the vent settings, based on tests or simulations. Using a physiology model that predicts thermophysiological responses of the occupant, the climate control function 1450, determines one or more thermal parameters associated with one or more body areas of the occupant based on the one or more input parameters. Using a psychology model that predicts a localized and whole-body thermal sensation and comfort of the occupant, the climate control function 1450 determines the overall thermal comfort level associated with a whole body of the occupant based on the one or more thermal parameters. The climate control function 1450 adjusts, based on the overall thermal comfort level and according to a predefined efficiency/time target, climate controls of the vehicle to modify a local thermal sensation of the one or more body areas of the occupant to achieve the overall thermal comfort level associated with the occupant, as described above.

All of the above is coordinated through the operating system 1422, which may be a real-time operating system. It should be appreciated that the climate control function 1450 may be integrated with or part of the operating system 1422, in some embodiments.

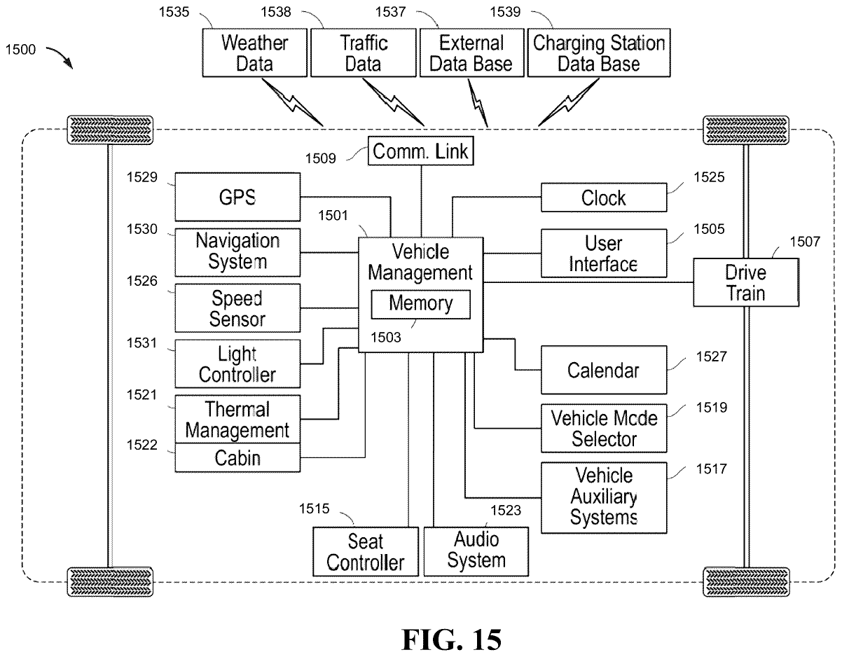

FIG. 15 is a high-level view of some embodiments of a vehicle 1500. Vehicle 1500 can be an electric vehicle (EV), a vehicle utilizing an internal combustion engine (ICE), or a hybrid vehicle, where a hybrid vehicle utilizes multiple sources of propulsion including an electric drive system. Vehicle 1500 includes vehicle management 1501 which is comprised of a processor (e.g., a central processing unit (CPU)). The vehicle management 1501 also includes memory 1503, with memory 1503 being comprised of EPROM, EEPROM, flash memory, RAM, solid state drive, hard disk drive, or any other type of memory or combination of memory types. It should be understood that the terms “vehicle management system,” “system controller” and “vehicle on-board system controller” can be used interchangeably throughout this disclosure. A user interface 1505 is coupled to the vehicle management 1501. User interface 1505 allows the driver, or a passenger, to interact with the vehicle management system, for example inputting data into the navigation system 1530, altering the heating, ventilation and air conditioning (HVAC) system via the thermal management system 1521, controlling the vehicle's entertainment system (e.g., radio, CD/DVD player, etc.), adjusting vehicle settings (e.g., seat positions, light controls, etc.), and/or otherwise altering the functionality of vehicle 1500. In at least some embodiments, user interface 1505 also includes means for the vehicle management system to provide information to the driver and/or passenger, information such as a navigation map or driving instructions (e.g., via the navigation system 1530 and GPS system 1529) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 1526), current HVAC settings such as cabin temperature and/or fan settings, etc.) via the thermal management system 1521. User interface 1505 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 1500 can also include other features like an internal clock 1525 and a calendar 1527.

In some embodiments, user interface 1505 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 1505 includes a graphical display, the vehicle management 1501 may also include a graphical processing unit (GPU), with the GPU being either separate from or contained on the same chip set as the processor.

Vehicle 1500 also includes a drive train 1507 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. The vehicle management 1501 monitors various vehicle functions that the driver may use to enhance the fit of the car to their own physical characteristics, such as seat position (e.g., seat position, seat height, seatback incline, lumbar support, seat cushion angle and seat cushion length) using seat controller 1515 and steering wheel position using an auxiliary vehicle system controller 1517. In some embodiments, the vehicle management 1501 also can monitor a driving mode selector 1519 which is used to control performance characteristics of the vehicle (e.g., economy, sport, normal). In some embodiments, the vehicle management 1501 can also monitor suspension characteristics using auxiliary vehicle system controller 1517, assuming that the suspension is user adjustable. In some embodiments, the vehicle management 1501 also monitors those aspects of the vehicle which are often varied by the user in order to match his or her environmental preferences for the cabin 1522, for example setting the thermostat temperature or the recirculation controls of the thermal management system 1521 that uses an HVAC controller, and/or setting the radio station/volume level of the audio system using controller 1523, and/or setting the lights, either internal lighting or external lighting, using light controller 1531. Also, besides using user-input and on-board sensors, the vehicle management 1501 can also use data received from an external on-line source that is coupled to the controller via communication link 1509 (using, for example, GSM, EDGE, UMTS, CDMA, DECT, WiFi, WiMax, etc.). For example, in some embodiments, the vehicle management 1501 can receive weather information using an on-line weather service 1535 or an on-line data base 1537, traffic data 1538 for traffic conditions for the navigation system 1530, charging station locations from a charging station database 1539, etc.

As an example, upon turning on the vehicle 1500, in some embodiments, the vehicle management 1501 identifies the current driver (and go to their last pre-set functions) or just go to the last pre-set functions for the vehicle (independent of who the current driver is), related to such features as: media functions, climate functions-heating, ventilation and air conditioning (HVAC) system, driving functions, seat positioning, steering wheel positioning, light control (e.g., internal lighting, external lighting, etc.), navigation functions, etc. Note that for purposes herein, the techniques will be described with reference to capacitive controllers. Even so, the techniques are not limited to the capacitive controllers and can be employed with other types of controllers.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent, or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer, or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In some embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of adjusting climate controls of a vehicle to achieve an overall thermal comfort level associated with an occupant of the vehicle, comprising:
obtaining one or more input parameters;
determining, using a physiology model that predicts thermophysiological responses of the occupant, one or more thermal parameters associated with one or more body areas of the occupant based on the one or more input parameters;
determining, using a psychology model that predicts a localized and whole body thermal sensation and comfort of the occupant, the overall thermal comfort level associated with a whole body of the occupant based on the one or more thermal parameters; and
adjusting, based on the overall thermal comfort level and according to a predefined efficiency target, climate controls of the vehicle to modify a local thermal sensation of the one or more body areas of the occupant to achieve the overall thermal comfort level associated with the occupant.

2. The method of claim 1, wherein the one or more input parameters include at least one of:
attributes associated with the occupant,
local conditions of the vehicle,
an initial skin temperature, or
an initial core temperature.

3. The method of claim 2, wherein the local conditions include at least one of:
an air temperature,
a relative humidity, or
an air speed.

4. The method of claim 2, further comprising:
obtaining the attributes associated with the occupant using sensors including at least one of:
infrared sensors,
piezoresistive sensors, or
ultrasonic sensors.

5. The method of claim 2, further comprising:
for each body area, determining the local conditions based on a climate control system of the vehicle;
determining the overall thermal comfort level based on the local conditions; and
determining the local conditions corresponding to a maximum value of the overall thermal comfort level.

6. The method of claim 5, wherein the climate control system includes at least one of:
a refrigerant system control, or
an air-system control.

7. The method of claim 1, wherein the one or more thermal parameters include at least one of:
a skin temperature,
a core temperature,
a rate of change of the skin temperature, or
a rate of change of the core temperature.

8. The method of claim 3, wherein the predefined efficiency target includes at least one of: a minimum energy budget and a minimum time to achieve the overall thermal comfort level associated with the occupant.

9. The method of claim 8, further comprising:
determining values of the local conditions that minimizes an energy budget to achieve the overall thermal comfort level associated with the occupant.

10. The method of claim 8, further comprising:
determining values of the local conditions that minimizes a time to achieve the overall thermal comfort level associated with the occupant.

11. The method of claim 1, further comprising:
for each of the one or more body areas of the occupant, determining a local thermal sensation;
identifying one or more target body areas having the local thermal sensation that corresponds to a maximum value of the overall thermal comfort level; and
directing one or more vents of the vehicle to the one or more target body areas to modify the local thermal sensation.

12. The method of claim 1, further comprising:
determining the overall thermal comfort level based on:
a duration of a predefined route between a start point to an end point, or
an energy budget for the predefined route to achieve the overall thermal comfort level associated with the occupant.

13. The method of claim 2, further comprising:
detecting a change in one or more of the local conditions;
updating the overall thermal comfort level, in response to the change in the one or more local conditions, to create an updated overall thermal comfort level; and
adjusting the local conditions based on the updated overall thermal comfort level.

14. The method of claim 13, further comprising:
generating feedback notifying the occupant of the change in the one or more of the local conditions in response to the detecting the change in the one or more local conditions.

15. The method of claim 1, wherein the vehicle includes transient non-uniform thermal environments.

16. The method of claim 1, wherein the psychology model is a joint system thermoregulation model (JOS-3) model, and wherein the psychology model is a Berkeley comfort model.

17. A vehicle, comprising:
a control system including:
a processor,
a memory coupled to the processor to store instructions, which when executed by the processor, cause the processor to perform operations, the operations comprising:
obtaining one or more input parameters;
determining, using a physiology model that predicts thermophysiological responses of an occupant, one or more thermal parameters associated with one or more body areas of the occupant based on the one or more input parameters;
determining, using a psychology model that predicts a localized and whole body thermal sensation and comfort of the occupant, an overall thermal comfort level associated with a whole body of the occupant based on the one or more thermal parameters; and
adjusting, based on the overall thermal comfort level and according to a predefined efficiency target, climate controls of the vehicle to modify a local thermal sensation of the one or more body areas of the occupant to achieve the overall thermal comfort level associated with the occupant.

18. The vehicle of claim 17, wherein the one or more input parameters include at least one of:
attributes associated with the occupant,
local conditions of the vehicle,
an initial skin temperature, or
an initial core temperature.

19. The vehicle of claim 18, wherein the local conditions include at least one of:
an air temperature,
a relative humidity, or
an air speed.

20. A non-transitory machine-readable storage medium having instructions stored therein, which when executed by a processor, cause the processor to perform operations, the operations comprising:
obtaining one or more input parameters;
determining, using a physiology model that predicts thermophysiological responses of an occupant, one or more thermal parameters associated with one or more body areas of the occupant based on the one or more input parameters;
determining, using a psychology model that predicts a localized and whole body thermal sensation and comfort of the occupant, an overall thermal comfort level associated with a whole body of the occupant based on the one or more thermal parameters; and
adjusting, based on the overall thermal comfort level and according to a predefined efficiency target, climate controls of a vehicle to modify a local thermal sensation of the one or more body areas of the occupant to achieve the overall thermal comfort level associated with the occupant.
